(19) United States
(12) Patent Application Publication
(10) Pub. No.: US 2011/0022321 A1
(43) Pub. Date: Jan. 27, 2011

(54) METHOD FOR MONITORING A SUBTERRANEAN FRACTURE

(76) Inventor: Jarl Huldén, Solna (SE)

Correspondence Address: NIXON & VANDERHYE, PC, 901 NORTH GLEBE ROAD, 11TH FLOOR, ARLINGTON, VA, 22203, US

(21) Appl. No.: 12/922,532

(22) PCT Filed: Mar. 10, 2009
(86) PCT No.: PCT/SE09/50247

§ 371 Date: Sep. 14, 2010

Related U.S. Application Data
(60) Provisional application No. 61/036,810, filed on Mar. 14, 2008.

(30) Foreign Application Priority Data
Mar. 14, 2008 (SE) 0800600-9

(51) Int. Cl. G01V 1/28; G06F 19/00

(52) U.S. Cl. 702/14

(57) ABSTRACT

The Invention relates to a method for monitoring a subterranean fracture, comprising determining by means of a plurality of seismic wave detectors (1a-1e) respective absolute or relative positions of a plurality of seismic events (k1-k.4) occurring as a result of hydraulic fracturing, and determining based at least partly on said positions of the events (k1-k.4) the orientation of a subterranean fracture (4) resulting from the hydraulic fracturing.

### TECHNICAL FIELD

The present invention relates to a method for monitoring a subterranean fracture.

### BACKGROUND

Hydraulic fracturing, where subterranean fractures are created by pumping a fracturing fluid into a borehole, is used in the oil and gas industry to recover oil or gas through the borehole communicating with a formation with hydrocarbon. Pumping provides a hydraulic pressure against the formation to initiate and expand fractures in the formation. Such a fracture typically extends laterally from the borehole. To prevent the fracture from closing when the pressure is relieved, the fracturing fluid typically carries into the fracture a granular or particulate material, known as “sand” or “proppant”, which remains in the fracture after the fracturing process is completed. The proppant is intended to keep the walls of the fracture spaced apart and provides flow paths through which hydrocarbons from the formation can flow.

An important aspect of hydraulic fracturing projects is the need to monitor and assess the formation of the fractures. U.S. Pat. No. 7,100,688B2 suggests for this purpose analyzing pressure frequency spectra and wave intensities from subterranean changes occurring during the fracturing process. Particularly, “a ridge of decreasing frequencies” is used as an indication of fracture expansion and “a ridge of increasing frequencies” is used as an indication of either closure or sand/proppant backing up in the fracture. However, such a method provides limited information about the fractures, and in particular no information about the position, orientation and extension of the fractures is provided.

U.S. Pat. No. 6,985,816B2 describes another hydraulic fracturing monitoring solution, in which a further borehole is provided in addition to the borehole for the subterranean treatment. In the further borehole sensors are positioned for monitoring purposes. As easily understood, the provision of such a further borehole increases the complexity and cost of a hydraulic fracturing project.

### SUMMARY OF THE INVENTION

It is an object of the invention to improve monitoring of subterranean fractures at hydraulic fracturing.

It is also an object of the invention to provide monitoring of subterranean fractures at hydraulic fracturing in a simple and cost-effective way.

These objects are reached by a monitoring a subterranean fracture, comprising
determining by means of a plurality of seismic wave detectors respective absolute or relative positions of a plurality of seismic events occurring as a result of hydraulic fracturing, and
determining based at least partly on said positions of the events the orientation of a subterranean fracture resulting from the hydraulic fracturing.

At least some of the seismic events occur during formation or expansion of the fracture. As exemplified below, the determination of the positions of the seismic events includes determining a position of each of the seismic wave detectors. The seismic events can occur at different points in time or essentially simultaneously.

The invention makes it possible to obtain, using a computer and suitable software, a three-dimensional visualization of fractures occurring at hydraulic fracturing. This gives operators a very useful tool to obtain an overview of fractures in the subterranean region being exploited. It will make it easier to plan further fracturing measures, and to assess the development of a hydraulic fracturing project. The invention provides for this with relatively simple tools, without the need for expensive additional measures, such as drilling extra boreholes for sensors.

Preferably, as exemplified below, the position and orientation of the subterranean fracture is determined using a Hough transform. Preferably, the Hough transform is a 3D Hough transform, wherein, for each position of the events, a plurality of planes are defined, each intersecting the respective position of the events, and the orientation of the subterranean fracture is determined based on the plurality of planes defined for each position of the events. As exemplified below, the determination of the orientation or the fracture can involve the determination of the azimuth and inclination of the fracture.

Preferably, the respective absolute positions of the seismic events are determined, and the position and orientation of the subterranean fracture are determined based at least partly on the absolute positions of the events. Thereby, the Hough transform can be used to determine also the position of the fracture.

Preferably, the delimitation of the subterranean fracture is determined based at least partly on the positions of the events and the position and orientation of the subterranean fracture.

Preferably, the respective positions of the seismic events are determined by:
recording, by means of the detectors, data relating to transient seismic waves generated at the hydraulic fracturing,
identifying, based on the seismic wave data from the detectors, the seismic events, and
determining positions oldie events, based at least partly on differences in arrival time, at least some of the detectors, of seismic waves from the events.

The objects are also reached by, a computer program according to claim 7, and by a computer program product according to claim 8.

### DESCRIPTION OF THE FIGURES

Below, the invention will be described in detail with reference to the drawings, in which

FIG. 1 shows schematically an arrangement at hydraulic fracturing,

FIG. 2 shows in a time-domain, signals detected by four detectors,

FIG. 3 shows in a time-domain, signals detected by two detectors,

FIG. 4 shows indications of positions of seismic events,

FIG. 5 shows parameters used for a 3D Hough transform,

FIG. 6 shows a diagram with a simplified example of selecting parameter values in the 3D Hough transform, and

FIG. 7 shows the arrangement in FIG. 1 with a fracture monitored according to an embodiment of the invention.

### DETAILED DESCRIPTION

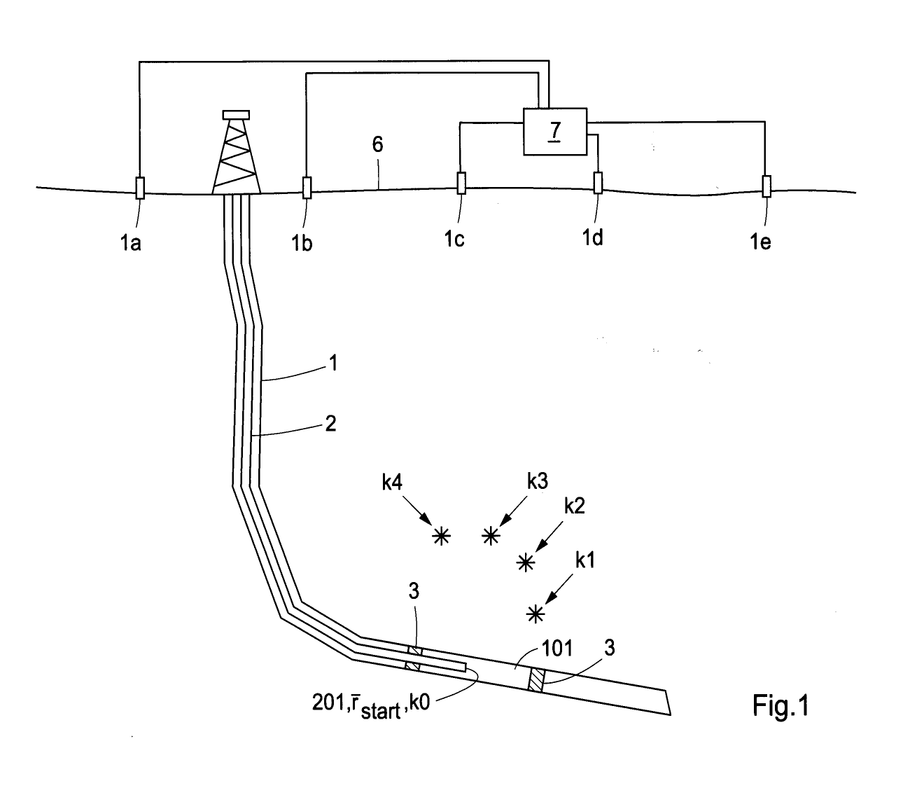

FIG. 1 shows schematically an arrangement at hydraulic fracturing. In a borehole 1 a tubing 2 is provided, A region 101 of the borehole 1 is sealed with suitable sealing devices 3, for example packers. An opening 201 in the tubing 2 is provided in the sealed region 101. The opening 201 is provided by setting off an explosive charge inserted through the borehole 1 and controlled in a manner known in the art. The explosion is herein referred to as an explosion event denoted k0 in FIG. 1. After the explosion event, a fracturing fluid is pumped under high pressure into the tubing 2 so that a fracture is initiated and formed in a formation adjacent to the sealed region 101. The fracturing fluid can be of any suitable type known in the art, and it is pumped into the borehole in any suitable manner known in the art. It should be noted that the inventions is applicable to techniques for hydraulic fracturing which differ from the one described here, and which are known to persons skilled in the art.

A plurality of seismic wave detectors 1a-1e, in the form of geophones, are distributed at spatially separate locations on the ground surface 6. The position of each detector 1a-1e is carefully registered and stored in a computer 7, to which the detectors are connected so as to provide detected signals to the computer 7. The connection of the detectors 1a-1e to the computer 7 can be provided with cables or it can be wireless. The computer 7 is provided with a computer program comprising computer readable code means causing the computer to perform steps of the method described below.

When the fracture is created, a number of seismic events as exemplified in FIG. 1 with star-shaped objects k1-k4, will occur. By means of the detectors 1a-1e the respective positions of the seismic events k1-k4 are determined. This can be done in a manner based on a method used for determining the relative position of microearthquake events described in Geophys. J. Int. (1995), 123, 409-419, by Slunga, Rögnvaldsson and Bödvarsson.

Thus, the respective positions of the seismic events can be determined by:
recording, by means of the detectors, data relating to transient seismic waves generated at the fracturing process, identifying, based on the seismic wave data from the detectors, the seismic events k1-k4, and
determining positions of the events, based at least partly on differences in arrival time, at least some of the detectors, of seismic waves from the events k1-k4.

More specifically, the respective positions of the seismic events can be determined as follows:

Referring to FIG. 1, a reference position is determined as an assumed “starting position” r̅ₛₜₐᵣₜ of the fracture. The starting position r̅ₛₜₐᵣₜ is assumed to be the position of the opening 201 of the tubing. Thus, the starting position is assumed to be the same position as the position of the explosion event k0. This position can be obtained in a number of manner, for example based on the geometry of the borehole 1 and the length of the tubing 2 inserted into the borehole 1. The geometry of the borehole may have been determined by determining, during drilling of the borehole 1, the position of the drill bit as described in the patent applications WO0175268 or WO2006078216 filed by the applicant.

Further, a seismic wave propagation velocity between the starting position r̅ₛₜₐᵣₜ and the detectors is determined, based on the starting position r̅ₛₜₐᵣₜ, the position of the respective detector, and seismic wave data recorded by the respective detector. For example, the seismic wave propagation velocity between the starting position r̅ₛₜₐᵣₜ and a detector can be determined by correlating the explosion event k0 at the starting position r̅ₛₜₐᵣₜ and seismic wave data recorded by the detector, to obtain a time of travel for the waves, and obtaining the velocity by dividing the distance between the starting position r̅ₛₜₐᵣₜ and the detector by the time of travel.

Thus, the seismic wave propagation velocities can differ from one detector to another. However, these velocities can be assumed to be the same for some or all of the detectors.

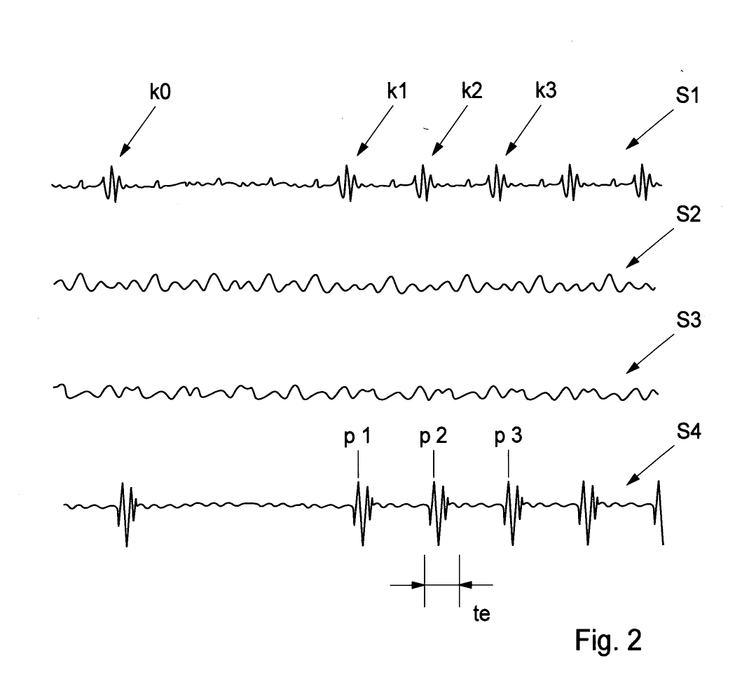

FIG. 2 shows seismic, wave data in the form of signals s1, s2, s3, s4, detected by four of the detectors, indicating the explosion event k0 and further seismic events k1, k2, k3. (Preferably, the signals are filtered in a manner known in the art.)

As can be seen in FIG. 2, an individual event k0, k1, k2, k3 is represented in the signal s1, s2, s3, s4 as a time region, te, with an increased signal amplitude. It can also be seen that the events of each signal have similar appearances. The signals s1, s2, s3, s4 are auto-correlated, which means that corresponding points in time p1, p2, p3 are chosen within the time regions, te, so that the relative time differences between the events within the signal can be unambiguously distinguished. In other words, a correlation between events, as detected by each detector, is calculated.

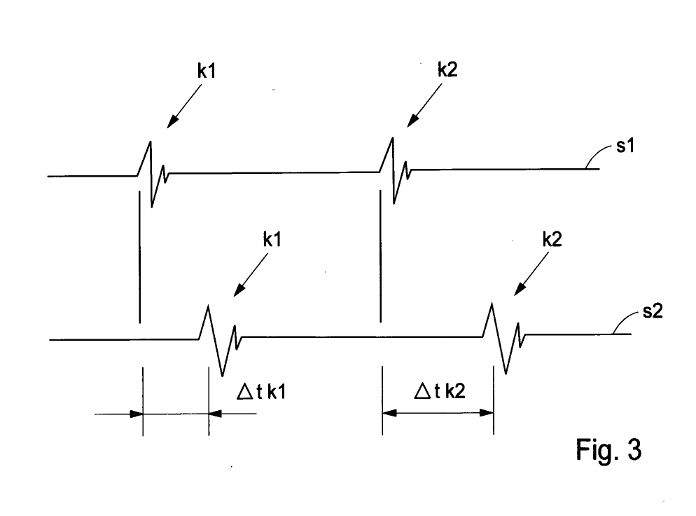

Reference is made to FIG. 3. Subsequently, the signals s1, s2, s3, s4 are cross-correlated, which means that the signals are mapped against each other so that parts thereof indicating the same events k1, k2 are identified. Thereby, signal curves from each detector can be time shifted and compared to each other to find a match. In other words, this step includes time-alignment of the signals of the detectors. The cross-correlation can be performed using a so called generalized cross-correlation (GCC) or a wavelet-based cross-correlation.

After the cross-correlation, for at least some of the detectors or signals s1, s2, difference in arrival time of seismic waves from two events k1, k2, one following the other, is determined. Since the “departure time” of the waves is unknown, a reference signal is used. Here the reference signal is a signal s1 from a detector other than the one for which a difference in arrival time of seismic waves is to be determined. This is exemplified in FIG. 3. For the detector providing the signal s2, the arrival times Δtk1. Δtk2 of the waves from a first and a second event k1, k2 are determined as the difference of absolute times between the detector for which a difference in arrival time of seismic waves is to be determined, and the reference signal s1. Thus, for a detector i, the observed difference in arrival time of seismic waves from two events k1, k2 is determined as t_{d}^{obs}(i,k₁,k₂)=Δtk2−Δtk1.

By using auto-correlation as described above, an arrival time difference between two events can be estimated with high accuracy. Also, the accuracy in the estimation can be assumed to be related to the cross-correlation value. Preferably, if the correlation between two successive events recorded by a detector, is less than a predefined value, preferably in the range 0.7-09, the resulting difference in arrival time may be discarded, assuming faulty influence or reflection disturbance.

Based on the seismic wave propagation velocity, (or velocities), and the difference in arrival time t_{d}^{obs}(i,k₁,k₂) of seismic waves at least some of the detectors, a position of the second event k2 in relation to a position of the first event k1 is determined. Three detectors can be used for this, resulting in a non-overdetermined equation system for solving the relative position of the second event k2. Preferably, in practice signals more than three detectors are used, which results in an over-determined equation system for determining the position of the second event k2.

To solve the over-determined problem, a sum of squared residual terms is minimised, the residual terms being arrival time difference residuals defined as

e_{d}(i,k₁,k₂)=t_{d}^{obs}(i,k₁k₂)−T(i,k₂)+T(i,k₁),

where t_{d}^{obs}(i,k₁,k₂) is the observed difference in arrival time, for detector i, for events k₁ and k₂, and T(i,k) is the theoretical arrival time, for event k. Such a sum of squared residual terms could be expressed as

$$Q = {\sum }_{i = 1}^{m} {\sum }_{{k}_{1} = 1}^{n - 1} {\sum }_{{k}_{2} = {k}_{1} + 1}^{n} {e}_{d}^{2} ( i , {k}_{1} {k}_{2} ) ,$$

where n is the number of seismic wave events. Including only a limited number of terms, such as the p last terms, limits the maximum processing steps needed for the estimation of the position of the event. If only the p last terms are included, Q could be expressed as

$$Q = {\sum }_{i = 1}^{m} {\sum }_{{k}_{1} = n - p - 1}^{n - 1} {\sum }_{{k}_{2} = {k}_{1} + 1}^{n} {e}_{d}^{2} ( i , {k}_{1} {k}_{2} ) .$$

Thus, minimising the sum Q above given values of the theoretical arrival times T(i,k). From the theoretical arrival times T(i,k) and the seismic wave propagation velocity, (or velocities), the relative distances, positions or vectors r̅_{d}(k₁,k₂) between events can be calculated. The relative distances, or vectors r̅_{d}(k₁,k₂) each give a position of an event in relation to a position of another event. In other words, the relative distances, r̅_{d}(k₁,k₂)= r̅(k₂)− r̅(k₁), between the positions of the events k₁ and k₂, are calculated so as to give theoretical arrival times T(i,k) which minimises Q.

Thus, a plurality of relative positions r̅_{d}(k₁,k₂)= r̅(k₂)− r̅(k₁) of the events are determined based on the seismic wave propagation velocity, (or velocities), and differences in arrival time t_{d}^{obs}(i,k₁,k₂), at detectors, of seismic waves from events k1, k2. The determined relative positions include the position of the explosion event k0 in relation to the other events k1-k4. Thus, since the position of the explosion event k0 is assumed, as explained above, to be the starting position r̅ₛₜₐᵣₜ, the absolute position of the respective event can be determined based on the starting position r̅ₛₜₐᵣₜ and a sum of the relative positions.

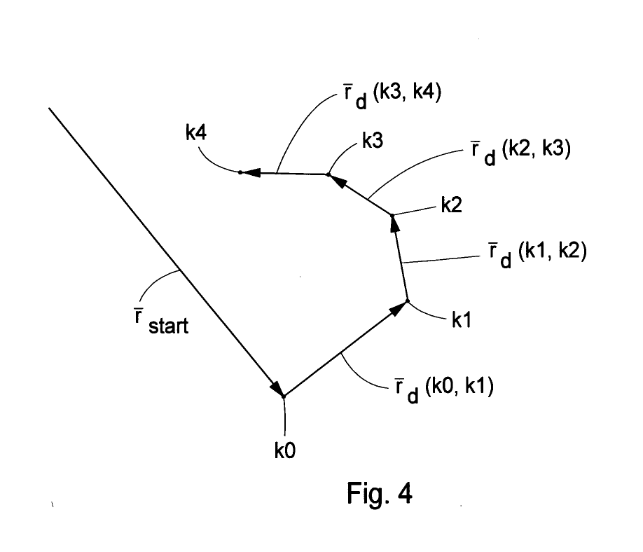

Referring to FIG. 4, the relative distances r̅_{d}(k0,k1), r̅_{d}(k1,k2), r̅_{d}(k2,k3), r̅_{d}(k3,k4) between the events, including the relative distance r̅_{d}(k0,k1) between the explosion event k0 and the event denoted k1, which minimise the sum of the arrival time difference residuals, are finally added to the starting position, r̅ₛₜₐᵣₜ, in order to establish the absolute positions of the events k1-k4. Thus, the absolute positions of the events can be determined as

r̅_{d}(k4)= r̅ₛₜₐᵣₜ+ r̅_{d}(k0,k1)+ r̅_{d}(k1,k2)+ r̅_{d}(k2,k3)+ r̅_{d}(k3,k4),

r̅_{d}(k3)= r̅ₛₜₐᵣₜ+ r̅_{d}(k0,k1)+ r̅_{d}(k1,k2)+ r̅_{d}(k2,k3)

r̅_{d}(k2)= r̅ₛₜₐᵣₜ+ r̅_{d}(k0,k1)+ r̅_{d}(k1,k2), and

r̅_{d}(k1)= r̅ₛₜₐᵣₜ+ r̅_{d}(k0,k1).

When the respective positions of the seismic events k1-k4 have been determined, the position and orientation of the fracture formed by the hydraulic fracturing are determined based on these event positions. This is done using a 3D Hough transform. Thereby it is assumed that the fracture can be represented by a plane, and the Hough transform is used to determine the position and orientation of the plane.

The assumption regarding a plane is reasonable, since such subterranean fractures in reality present mainly planar extensions.

The Hough transform is a feature extraction technique often used in image analysis, computer vision and digital image processing. The simplest case of Hough transform is the linear transform for detecting straight lines. The 3D Hough transform is known for example from F. Tarsha-Kurdi, T. Landes, P. Grussenmeyer, “Hough-Transform and Extending Ransac Algorithms for Automatic Detection of 3D Building Roof Planes from Lidar Data”, IAPRS Volume XXXVI, Part 3/W52, 2007.

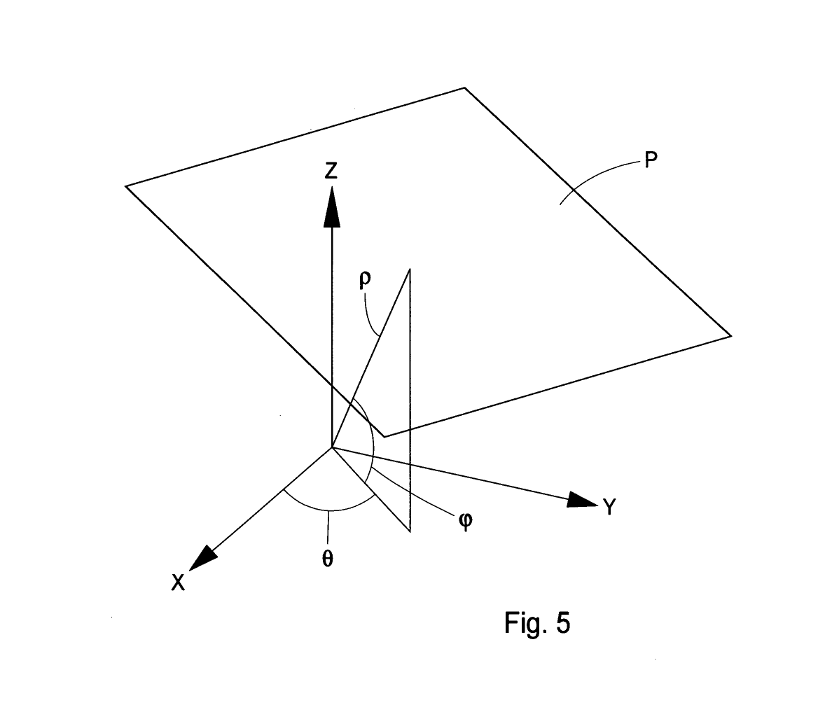

Referring to FIG. 5, a useful example of the 3D transform defines a plane P by the three parameters azimuth θ, inclination φ and distance ρ, instead of the Cartesian coordinates x, y, z. The azimuth θ specifies the angular direction in the x-y-plane towards which the plane P is tilted, the inclination φ specifies the angle of a normal of the plane P to the x-y-plane, and the distance ρ specifies the distance of the plane P from the origin of the x-y-z-system.

For each event k0-k4 position determined as described above, a number of alternative planes P, all intersecting the respective event position, are defined. The alternative planes P intersecting a certain event position differ from each other regarding the values of the parameters azimuth θ, inclination φ and distance ρ. The values of these parameters for all alternative planes at all event k0-k4 positions are used to fill a so called accumulator array. Thereby, each value of the parameters obtains “votes” and the values obtaining the largest amount of votes are chosen for the plane P determined to define the orientation and position of the fracture in the subterranean formation.

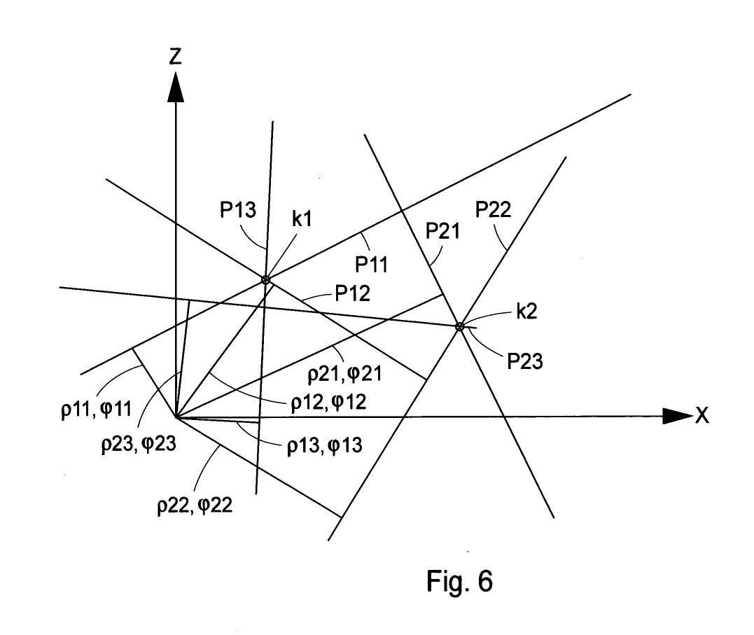

To illustrate the determination of the orientation and position of the fracture, reference is made to a simplified depiction in FIG. 6. For each of two positions of respective events (k1, k2), three planes P11, P12, P13, P21, P22, P23 are defined, each intersecting the respective event position. (In practice, considerably more than three planes are defined per event position.) In FIG. 6, a two-dimensional presentation is made, in which the planes are represented by lines, and defined by two, φ, ρ, instead of three parameters. However, the three-dimensional case differs only in that an additional parameter, θ, is included, (see above with reference to FIG. 5). Thus, in FIG. 6, each of the planes are defined by pairs of parameter values φ11, ρ11, φ12, ρ12, φ13, ρ13, φ21, ρ21, φ22. ρ22, φ23, ρ23. These parameter values are matched with predefined parameter value intervals, and the parameter value intervals receiving the largest amount of parameter values, are chosen to define the orientation and position of the fracture.

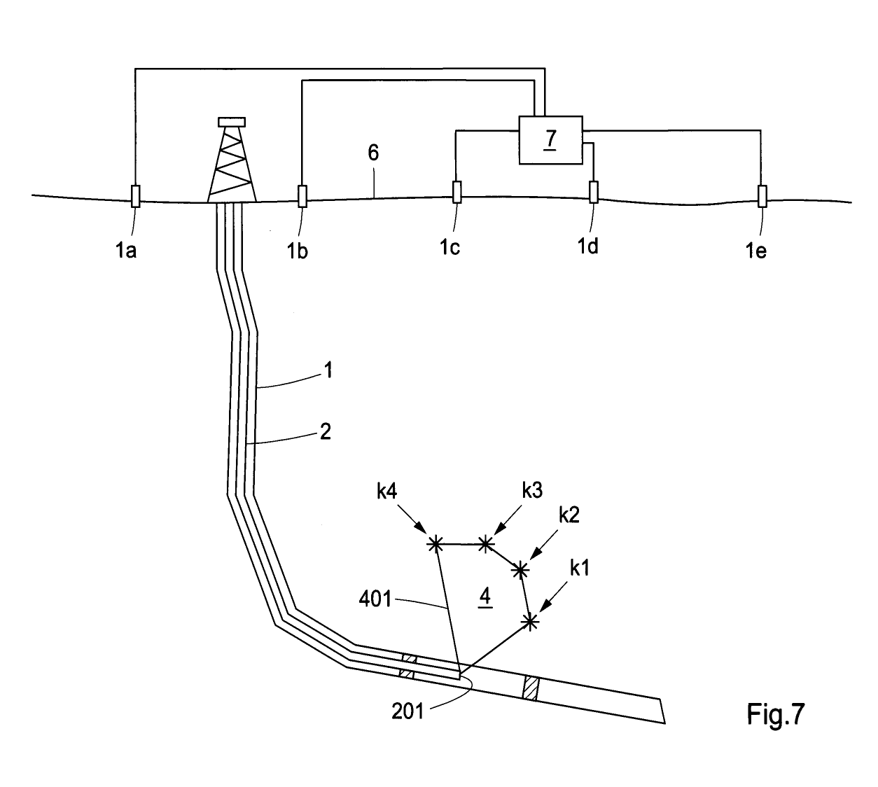

Reference is made to FIG. 7. To determine the delimitation of the fracture, the projection of each event k0-k4 position onto the plane P, chosen by the 3D Hough transform, is determined. A fracture delimitation line 401 in the plane P is determined using a suitable line fitting algorithm, which fracture delimitation line 401 intersects the event position projections. Thereby, the position, orientation, and delimitation of the fracture 4 can be modeled, for example in order to be visualized on a computer screen.

While the hydraulic fracturing process is continued, the fracture 4 is extended due to the fracturing fluid pressure. In FIG. 7, the fracture 4 is depicted as extending in only one direction, but in reality the fracture 4 can of course extend in two or more directions from the borehole 1. As the hydraulic fracturing process progresses, the expansion of the fracture 4 will give rise to further seismic events. More specifically, the expansion of the fracture 4 will take place in a stepwise manner, the edge of the fracture being moved outwards at each step. At each such expansion step, one or more further seismic events will occur. It is assumed that such seismic events mainly occur along the “new”, extended fracture edge.

Using the method described above, the expansion of the fracture during the hydraulic fracturing can be monitored, and the model of the position, orientation, and delimitation of the fracture 4 can be updated accordingly.

Alternatives to the method described above are possible within the scope of the claims. For example, the orientation of the fracture can be determined based on the relative positions of the events k0-k4, and the absolute position of the fracture can be determined after or in conjunction with the determination of the absolute position or the events k1-k4, as described above with reference to FIG. 4.

1. A method for monitoring a subterranean fracture, comprising
determining by means of a plurality of seismic wave detectors (1a-1e) respective absolute or relative positions of a plurality of seismic events (k1-k4) occurring as a result of hydraulic fracturing, and
determining based at least partly on said positions of the events (k1-k4) the orientation of a subterranean fracture (4) resulting from the hydraulic fracturing.

2. A method according to claim 1, wherein the orientation of the subterranean fracture is determined using a Hough transform.

3. A method according to claim 2, wherein the Hough transform is a 3D Hough transform, wherein, for each position of the events (k1-k4), a plurality of planes are defined, each intersecting the respective position of the events (k1-k4), and the orientation of the subterranean fracture is determined based on the plurality of planes defined for each position of the events (k1-k4).

4. A method according to claim 1, wherein the respective absolute positions of the seismic events (k1-k4) are determined, and the position and orientation of the subterranean fracture (4) are determined based at least partly on the absolute positions of the events (k1-k4).

5. A method according to claim 4, wherein the delimitation (401) of the subterranean fracture is determined based at least partly on the positions of the events (k1-k4) and the position and orientation of the subterranean fracture (4).

6. A method according to claim 1, wherein the respective positions of the seismic events are determined by:
recording, by means of the detectors (1a-1e), data relating to transient seismic waves generated at the hydraulic fracturing,
identifying, based on the seismic wave data from the detectors, the seismic events (k1-k4), and
determining positions of the events (k1-k4), based at least partly on differences in arrival time, at least some of the detectors (1a-1e), of seismic waves from the events (k1-k4).

7. A computer program comprising computer readable code means causing a computer to perform the steps of the method according to claim 1.

8. A computer program product comprising a computer readable medium, having stored thereon a computer program according to claim 7.
